(19) United States
(12) Patent Application Publication
(10) Pub. No.: US 2022/0043610 A1
(43) Pub. Date: Feb. 10, 2022

(54) STORAGE DEVICE DECOUPLING DETERMINATION

(71) Applicant: Hewlett-Packard Development Company, L.P., Spring, TX (US)

(72) Inventors: Pooja Bansal, Bangalore (IN); Shinoj Bhaskaran, Bangalore (IN)

(73) Assignee: Hewlett-Packard Development Company, L.P., Spring, TX (US)

(21) Appl. No.: 17/294,547

(22) PCT Filed: Feb. 28, 2020
(86) PCT No.: PCT/US2020/020315

§ 371 Date: May 17, 2021

(30) Foreign Application Priority Data
Apr. 30, 2019 (IN) IN201941017124

(51) Int. Cl. G06F 3/12; H04N 1/00

(52) U.S. Cl. CPC G06F 3/1204; H04N 1/0049; H04N 1/00488; G06F 3/1238

(57) ABSTRACT

Examples disclosed herein relate to detecting a storage device directly coupled to a print device, associating the storage device with a user, retrieving a print job from the storage device, determining whether the storage device has been decoupled, and in response to determining that the storage device has not been decoupled, pause printing of the print job.

### BACKGROUND

Multi-function devices often combine different components such as a printer, scanner, and copier into a single device. Such devices frequently receive refills of consumables, such as print substances (e.g., ink, toner, and/or additive materials) and/or media (e.g., paper, vinyl, and/or other print substrates).

### BRIEF DESCRIPTION OF THE DRAWINGS

FIG. 1 is a block diagram of an example computing device for providing storage device decoupling determination.

FIG. 2 is a block diagram of an example system for providing storage device decoupling determination.

FIG. 3 is a flowchart of an example method for providing storage device decoupling determination.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations consistent with the description; however, the description is not limited to the examples and/or implementations provided in the drawings.

### DETAILED DESCRIPTION

Most multi-function-print devices (MFPs) provide several features, such as an option to scan a physical document, which may be controlled via an on-device control panel, a connected application, and/or a remote service. Other options may include printing, copying, faxing, document assembly, etc. The scanning portion of an MFP may comprise an optical assembly located within a sealed enclosure. The sealed enclosure may have a scan window through which the optical assembly can scan a document, which may be placed on a flatbed and/or delivered by a sheet feeder mechanism.

Many MFPs are configured to receive print jobs from a variety of sources, such as a cable connection to a computing device, via a wired and/or wireless connection, and/or from a directly coupled storage device. For example, the MFP may have a Universal Serial Bus (USB) port to receive a portable storage device. Such portable storage devices may comprise, for example, a USB “thumb drive” and/or a portable hard drive. These storage devices may store one and/or more print jobs in various formats, including native formats such as portable document files (PDF) or word processing documents and/or in ready-to-print pre-rendered formats.

In many cases, users forget to decouple and retrieve the storage device after printing. This can compromise the user's data stored on the storage device if another user then takes the storage device and/or retrieves data, such as by printing another copy of the stored print jobs, before the original user remembers to return and retrieve it.

In some implementations, the MFP and/or another device may provide a reminder to the user to decouple and retrieve the storage device. For example, the MFP may detect a user's presence, such as through proximity sensors, a camera, and/or a connection (e.g., via Bluetooth) to the user's mobile device. If the user's presence is detected to leave the proximity of the MFP while the storage device remains directly coupled to the MFP, the reminder may be sent, such as by an alert to the mobile device and/or an audible alarm from the MFP. For another example, the MFP may send the reminder after a configurable time (e.g., two minutes) after the print job has been retrieved from the storage device and the storage device remains directly coupled.

In some implementations, after the user chooses the document to be printed from the storage device, the MFP may copy the data to internal memory and prompt the user to decouple the storage device to continue the print job. Once the user decouples the storage device, the MFP may continue with processing the print job. If the user wants to print multiple files, the prompt may be modified with an option to choose the next file to print and/or to decouple the storage device out if the last file has been selected.

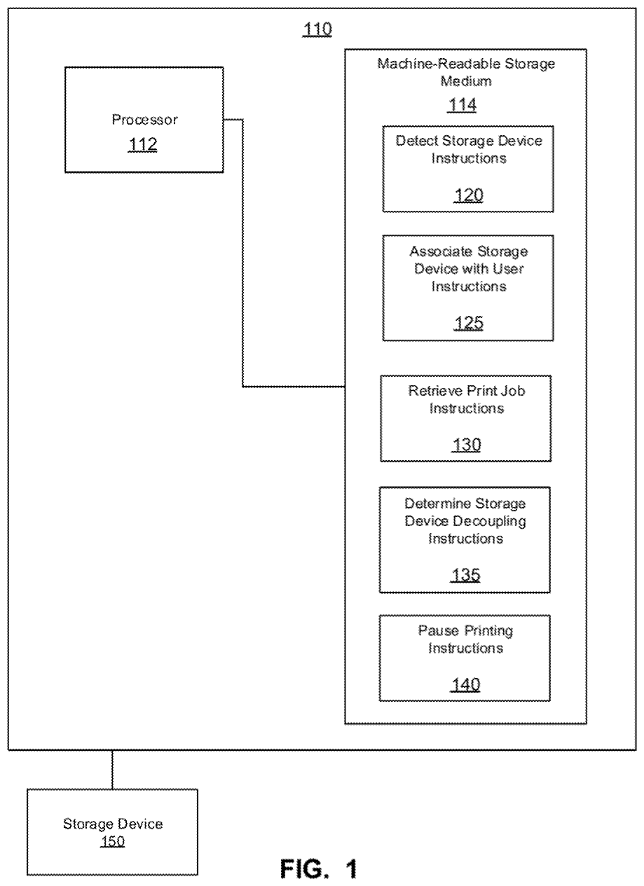

FIG. 1 is a block diagram of an example computing device 110 for providing storage device decoupling determination. In some implementations, computing device 110 may comprise a print device, such as an MFP. Computing device 110 may comprise a processor 112 and a non-transitory, machine-readable storage medium 114. Storage medium 114 may comprise a plurality of processor-executable instructions, such as instructions 120 and instructions 125. In some implementations, instructions 120, 125 may be associated with a single computing device 110 and/or may be communicatively coupled among different computing devices such as via a direct connection, bus, or network.

Processor 112 may comprise a central processing unit (CPU), a semiconductor-based microprocessor, a programmable component such as a complex programmable logic device (CPLD) and/or field-programmable gate array (FPGA), or any other hardware device suitable for retrieval and execution of instructions stored in machine-readable storage medium 114. In particular, processor 112 may fetch, decode, and execute detect storage device instructions 120, associate storage device with user instructions 125, retrieve print job instructions 130, determine storage device decoupling instructions 135, and/or pause printing instructions 140.

Executable instructions 120, 125, 130, 135, 140 may comprise logic stored in any portion and/or component of machine-readable storage medium 114 and executable by processor 112. The machine-readable storage medium 114 may comprise both volatile and/or nonvolatile memory and data storage components. Volatile components are those that do not retain data values upon loss of power. Nonvolatile components are those that retain data upon a loss of power.

The machine-readable storage medium 114 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, and/or a combination of any two and/or more of these memory components. In addition, the RAM may comprise, for example, static random access memory (SRAM), dynamic random access memory (DRAM), and/or magnetic random access memory (MRAM) and other such devices. The ROM may comprise, for example, a programmable read-only memory (PROM), an erasable programmable read-only memory (EPROM), an electrically erasable programmable read-only memory (EEPROM), and/or other like memory device.

Detect storage device instructions 120 may detect, a storage device 150 directly coupled to a print device. Storage device 150 may comprise any portable data storage medium and an associated coupling mechanism, such as a cable and/or interface connector. Storage device 150 may, for example, comprise a USB thumb drive, a firewire-based storage device, and/or a network attached storage coupled via a network cable. In some implementations, the instructions to detect the storage device 150 directly coupled to a print device may comprise instructions to display a security notification on the print device informing the user of a policy preventing printing of the print job while the storage device 150 remains directly coupled to the print device. For example, a control panel of the print device may display a message informing the user that they need to decouple the storage device 150 before a file may be printed.

Associate storage device with user instructions 125 may associate the storage device 150 with a user. In some implementations, the instructions 125 to associate the storage device 150 with a user may comprise instructions to detect a portable electronic device (e.g., a smartphone) associated with the user. The portable electronic device may, for example, be wirelessly coupled to the print device, such as via a WiFi network, Bluetooth, and/or near field communication (NFC) protocol. In some implementations, the instructions to associate the storage device 150 with a user may comprise instructions to request information (e.g., a login and/or email address) from the user, such as via the control panel of the print device.

Retrieve print job instructions 130 may retrieve a print job from the storage device 150. For example, the user may use a control panel and/or mobile device app to navigate a user interface allowing selection of a file from the storage device 150. The print device may then copy the selected file to local memory (e.g., storage medium 114) to prepare it for printing.

Determine storage device decoupling instructions 135 may determine whether the storage device 150 has been decoupled. For example, instructions 135 may determine whether a USB drive from which the print job was retrieved remains plugged into a port on the print device. In some implementations, the instructions to determine whether the storage device 150 has been decoupled may comprise instructions to determine whether a configurable amount of time has elapsed since the print job was retrieved. For example, an administrator of the print device may set a time of two minutes after a print job is retrieved before determining that the storage device 150 may have been forgotten. In some implementations, the instructions to determine whether the storage device has been decoupled may comprise instructions to determine whether the user has left the proximity of the print device. For example, the print device may determine that a connected mobile device associated with the user and with the storage device 150 has disconnected, such as by moving out of Bluetooth range of the print device. In some implementations, the instructions to determine whether the storage device 150 has been decoupled may comprise instructions to, in response to determining that the storage device 150 has been decoupled, print the print job.

Pause printing instructions 140 may, in response to determining that the storage device 150 has not been decoupled, pause printing of the print job. In some implementations, the instructions 140 to pause printing of the print job may comprise instructions to send a notification to the portable electronic device associated with the user, such as via a text message and/or app notification. In some implementations, the instructions to pause printing of the print job may comprise instructions to emit an audible alarm from the print device, such as a beep and/or other alert tone and/or display a notification on the print device, such as a message on the control panel or light code.

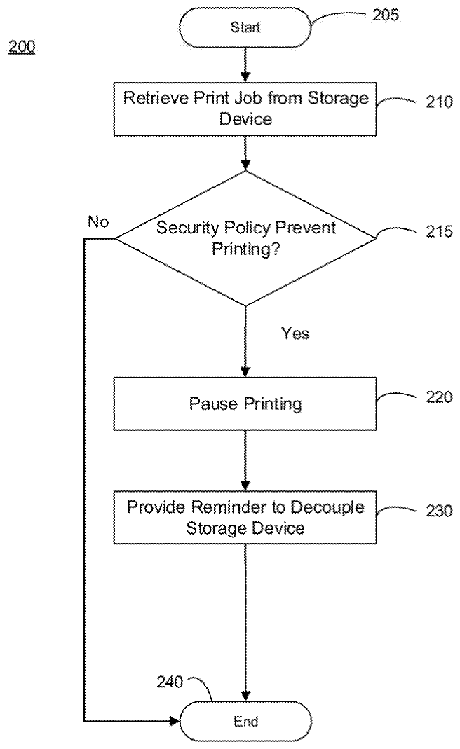

FIG. 2 is a flowchart of an example method 200 for storage device decoupling determination. Although execution of method 200 is described below with reference to computing device 110, other suitable components for execution of method 200 may be used.

Method 200 may begin at stage 205 and advance to stage 210 where device 110 may retrieve a print job from a storage device 150 directly coupled to a printer.

Method 200 may then advance to stage 215 where computing device 110 may determine whether a security policy prevents printing of the print job while the storage device remains coupled. For example, an administrator of the print device may enable the security policy comprising a configuration setting on the print device that prohibits printing of a file while the storage device 150 from which the file was copied remains coupled to the print device.

In response to determining that the security policy prevents printing of the print job while the storage device remains coupled, method 200 may advance to stage 220 where computing device 110 may pause printing of the print job until the storage device becomes uncoupled. For example, the print device may copy the file to local storage from the storage device 150 and/or may prepare the file for printing (e.g., by rendering the file into a printer control language), but may not begin actually sending the data to the print engine for printing on the paper and/or other medium.

Method 200 may then advance to stage 215 where computing device 110 may provide a reminder to decouple the storage device 150. In some implementations, the print device may provide an audible and/or a visual alert. For example, the print device may display a message on a control panel, flash a light code via lights on the print device's chassis, provide an audible alert tone, and/or send a message to the user, such as may be displayed on a mobile device associated with the user, such as an email and/or text message. The mobile device may be associated with the user, for example, by detecting the mobile device presence at the printer via Bluetooth and/or NFC, and/or may be associated via a phone number and/or email address associated with a user's account. Such an account may be verified by the printer by requesting a login from the user before copying the file to be printed from the storage device 150.

Method 200 may then end at stage 250.

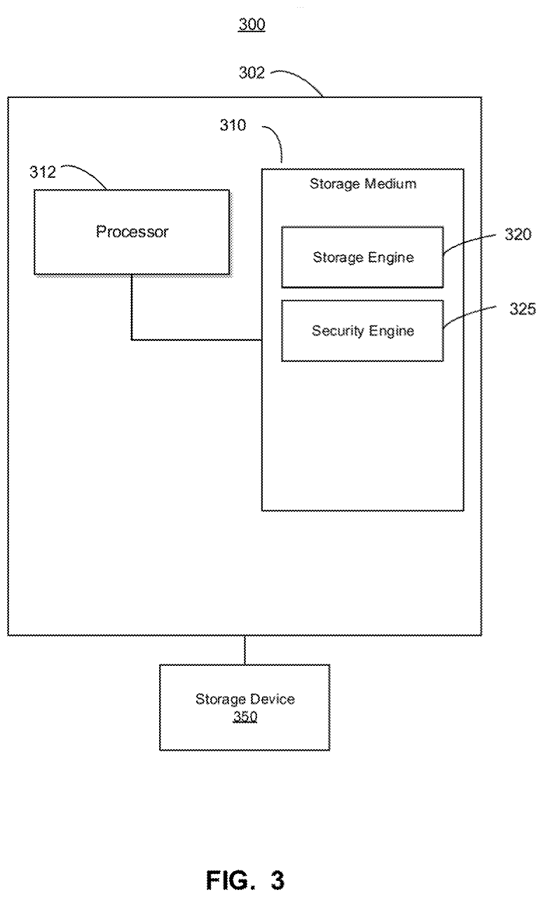

FIG. 3 is a block diagram of an example apparatus 300 for providing storage device decoupling determination. Apparatus 300 may comprise a multi-function printer device 302 comprising a storage medium 310, and a processor 312. Device 302 may comprise and/or be associated with, for example, a general and/or special purpose computer, server, mainframe, desktop, laptop, tablet, smart phone, game console, printer, multi-function device, and/or any other system capable of providing computing capability consistent with providing the implementations described herein. Device 302 may store, in storage medium 310, a storage engine 320 and a security engine 325.

Each of engines 320, 325 may comprise any combination of hardware and programming to implement the functionalities of the respective engine. In examples described herein, such combinations of hardware and programming may be implemented in a number of different ways. For example, the programming for the engines may be processor executable instructions stored on a non-transitory machine-readable storage medium and the hardware for the engines may include a processing resource to execute those instructions. In such examples, the machine-readable storage medium may store instructions that, when executed by the processing resource, implement engines 320, 325. In such examples, device 302 may comprise the machine-readable storage medium storing the instructions, and the processing resource to execute the instructions, or the machine-readable storage medium may be separate but accessible to apparatus 300 and the processing resource.

Storage engine 320 may detect a storage device directly coupled to a print device, retrieve a print job from the storage device, and associate the storage device with a user. For example, a storage device 350 may comprise a storage medium comprising a USB connector that may be inserted into a USB port of print device 302. The user may select a file from storage device 350, such as via a user interface displayed on a control panel of print device 302. The user may be associated with storage device 350, for example, by requiring the user to login to print device 302 and/or by detecting a mobile device, such as a smartphone, in proximity to print device 302 during the file selection from the storage device 350.

Security engine 325 may determine whether the storage device has been decoupled from the print device, and, in response to determining that the storage device has not been decoupled from the print device, prevent the print job from being printed and provide a reminder to the user to decouple the storage device. For example, if storage device 350 remains plugged into a USB port of print device 302 after the file to be printed has been copied off of storage device 350, the file may not be printed until such time as the storage device 350 has been decoupled from the USB port. In some implementations, print device 302 may notify the user, such as by an audible and/or a visual alert.

For example, the print device may display a message on a control panel, flash a light code via lights on the print device's chassis, provide an audible alert tone, and/or send a message to the user, such as may be displayed on a mobile device associated with the user, such as an email and/or text message. The mobile device may be associated with the user, for example, by detecting the mobile device presence at the printer via Bluetooth and/or NFC, and/or may be associated via a phone number and/or email address associated with a user's account. Such an account may be verified by the printer by requesting a login from the user before copying the file to be printed from the storage device 350.

In the foregoing detailed description of the disclosure, reference is made to the accompanying drawings that form a part hereof, and in which is shown by way of illustration how examples of the disclosure may be practiced. These examples are described in sufficient detail to allow those of ordinary skill in the art to practice the examples of this disclosure, and it is to be understood that other examples may be utilized and that process, electrical, and/or structural changes may be made without departing from the scope of the present disclosure.

What is claimed is:

1. A non-transitory machine readable medium storing instructions executable by a processor to:
detect a storage device directly coupled to a print device;
associate the storage device with a user;
retrieve a print job from the storage device;
determine whether the storage device has been decoupled; and
in response to determining that the storage device has not been decoupled, pause printing of the print job.

2. The non-transitory machine readable medium of claim 1, wherein the instructions to associate the storage device with a user comprise instructions to detect a portable electronic device associated with the user.

3. The non-transitory machine readable medium of claim 2, wherein the portable electronic device is wirelessly coupled to the print device.

4. The non-transitory machine readable medium of claim 2, wherein the instructions to pause printing of the print job further comprise instructions to send a notification to the portable electronic device associated with the user.

5. The non-transitory machine readable medium of claim 2, wherein the instructions to pause printing of the print job further comprise instructions to emit an audible alarm from the print device.

6. The non-transitory machine readable medium of claim 1, wherein the instructions to detect the storage device directly coupled to a print device further comprise instructions to display a security notification on the print device informing the user of a policy preventing printing of the print job while the storage device remains directly coupled to the print device.

7. The non-transitory machine readable medium of claim 1, wherein the instructions to determine whether the storage device has been decoupled further comprise instructions to determine whether a configurable amount of time has elapsed since the print job was retrieved.

8. The non-transitory machine readable medium of claim 1, wherein the instructions to determine whether the storage device has been decoupled further comprise instructions to determine whether the user has left the proximity of the print device.

9. The non-transitory machine readable medium of claim 1, wherein the instructions to determine whether the storage device has been decoupled further comprise instructions to, in response to determining that the storage device has been decoupled, print the print job.

10. A method comprising:
retrieving a print job from a storage device directly coupled to a printer;
determining whether a security policy prevents printing of the print job while the storage device remains coupled; and
in response to determining that the security policy prevents printing, of the print job while the storage device remains coupled:
pausing printing of the print job until the storage device becomes uncoupled; and
providing a reminder to decouple the storage device.

11. The method of claim 10, wherein the storage device is associated with a user and wherein providing the reminder to decouple the storage device comprises sending a message to the user.

12. The method of claim 11, wherein sending the message to the user comprises sending the message to be displayed on a mobile device associated with the user.

13. The method of claim 11, wherein providing the reminder to decouple the storage device comprises providing at least one of an audible and a visual alert by the printer.

14. A system, comprising:
a storage device engine to:
detect a storage device directly coupled to a print device,
retrieve a print job from the storage device, and
associate the storage device with a user; and
a security engine to:
determine whether the storage device has been decoupled from the print device, and
in response to determining that the storage device has not been decoupled from the print device:
prevent the print job from being printed, and
provide a reminder to the user to decouple the storage device;

15. The system of claim 14, wherein the reminder to the user comprises a message to be displayed on a mobile device associated with the user.
